(19) United States
(12) Patent Application Publication
(10) Pub. No.: US 2008/0161444 A1
(43) Pub. Date: Jul. 3, 2008

(54) ORGANIC-INORGANIC COMPOSITE FORMING MATERIAL, ORGANIC-INORGANIC COMPOSITE AND OPTICAL ELEMENT USING THE SAME

(75) Inventors: Nobuhiko HAYASHI, Osaka-city (JP); Mitsuaki MATSUMOTO, Hirakata-city (JP); Masaya NAKAI, Hirakata-city (JP); Keiichi KURAMOTO, Kadoma-city (JP)

Correspondence Address: DITTHAVONG MORI & STEINER, P.C., 918 Prince St., Alexandria, VA, 22314, US

(73) Assignee: SANYO ELECTRIC CO., LTD., Moriguchi-city (JP)

(21) Appl. No.: 11/847,091

(22) Filed: Aug. 29, 2007

(30) Foreign Application Priority Data
Aug. 30, 2006 (JP) 2006-233973
May 30, 2007 (JP) 2007-142854

(51) Int. Cl. C08K 3/22

(52) U.S. Cl. 522/81; 522/83

(57) ABSTRACT

An organic-inorganic composite forming material is disclosed which contains a fluorene-based compound having an acryloyl or methacryloyl group, an acrylic monomer other than the fluorene-based compound, metal oxide fine particles, an alkylamine, an organic amine having a phenyl group and a photoinitiator.

### BACKGROUND OF THE INVENTION

1. Technical Field

The present invention relates to an organic-inorganic composite forming material which contains metal oxide fine particles and can form a high-refractive organic-inorganic composite, an organic-inorganic composite obtained via polymerization thereof and an optical element.

2. Description of Related Art

An aspherical lens can reduce aberration, so its use allows reduction in number of the lenses used and thus enables reduction in size, weight and cost of a product. Accordingly, there is an increasing demand in camera-mounted mobile phones and digital cameras for such aspherical lenses.

A glass-made aspherical lens is hard to fabricate by polishing. A mold glass using a low-melting glass raises a problem of a shortened service life of a mold. Accordingly, they are not suited to low-cost mass production.

On the other hand, a resin-made aspherical lens is more processable than glass and easy to mass-produce. However, organic compounds excepting halogen and sulfur compounds have refractive indexes of up to 1.6 at the most, even if they contain a phenyl or the like group that increases their refractive indexes, so a refractive index of a resin is lower than that of glass. Accordingly, fabrication of an aspherical lens using a resin reduces a freedom in product design, which makes it problematically difficult to achieve reduction in size and weight of a product.

As a measure to increase a refractive index of a resin, incorporation of nanoparticles of a high-refractive metal oxide such as ZnO₂, Nb₂O₅ or TiO₂ is known. Liquid dispersions of nanoparticles of a metal oxide such as ZnO₂, Nb₂O₅ or TiO₂ are disclosed, for example, in Japanese Patent Laid-Open Nos. 2005-306641 and 2003-192348.

These liquid dispersions of metal oxide nanoparticles contain an organic carboxylic acid and an organic amine which ease dispersion of such metal oxide nanoparticles in an organic solvent such as ethanol. A methanol dispersion of niobium oxide is commercially available from Taki Chemical Co., Ltd. under the product name “BYLAL”, for example.

In the case where metal oxide nanoparticles are mixed in a resin to prepare a high-refractive resin, the following two problems arise.

A first problem is that incorporation of metal oxide nanoparticles in a resin deteriorates strength of the resin. For example, cracks occur when it is placed under a prolonged high-temperature high-humidity atmosphere or subjected to a thermal cycle test in which high-low temperature cycling is repeated. In particular, the occurrence of cracks increases with an increasing amount of the nanoparticles incorporated.

A second problem is that these metal oxides are highly water-soluble, so that they are more compatible with highly water-soluble resins but less compatible with water-insoluble resins. Incorporation of metal oxide nanoparticles in a water-insoluble resin creates a problem of clouding that occurs as a result of agglomeration thereof. A resin containing many phenyl or naphthyl groups is high in refractive index and thus useful for preparation of a high-refractive resin composition. However, a resin containing a phenyl or naphthyl group, because of its high tendency to become water-insoluble, is hard to disperse metal oxide nanoparticles therein. Accordingly, the effort to prepare a high-refractive resin composition by mixing metal oxide nanoparticles in a resin having many phenyl or naphthyl groups has encountered problems, including clouding of a resin composition due to poor dispersion of the metal oxide nanoparticles.

On the other hand, when metal oxide nanoparticles are mixed in a resin having no or little phenyl or naphthyl group, a relatively good dispersion is obtained. However, if a high refractive index is to be obtained, a large amount of such metal oxide nanoparticles must be added. This presents a problem of reduction in strength of a resin composition.

For the forgoing reasons, it has been conventionally difficult to incorporate metal oxide nanoparticles in a resin containing many phenyl or naphthyl groups, such as a fluorene resin or other high-refractive resin, in a well-dispersed condition.

It is an object of the present invention to provide an organic-inorganic composite forming material in which metal oxide fine particles are dispersed in a fluorene-based resin without the occurrence of clouding and which can thus form a high-refractive organic-inorganic composite, an organic-inorganic composite made via polymerization of the organic-inorganic composite forming material and an optical element using the organic-inorganic composite.

### SUMMARY OF THE INVENTION

The organic-inorganic composite forming material of this invention is characterized as containing a fluorene-based compound having an acryloyl or methacryloyl group, an acrylic monomer other than the fluorene-based compound, fine particles of metal oxide, an alkylamine, an organic amine having a phenyl group, and a photoinitiator.

In the present invention, the inclusion of alkylamine and organic amine having a phenyl group enhances dispersibility of the metal oxide fine particles, so that the metal oxide fine particles can be mixed in the fluorene-based compound in such a well-dispersed condition that does not cause clouding.

The alkylamine is believed to enhance dispersibility of the metal oxide fine particles in the organic solvent and resin. Also, the organic amine having a phenyl group is believed to improve their dispersibility in a water-insoluble resin. Thus, dispersibility of metal oxide fine particles can be controlled by adjusting a blending ratio of the alkylamine and organic amine having a phenyl group.

Those amine compounds disclosed in Patent Literatures 1 and 2 can be used as the alkylamine. Specific examples of alkylamines include primary amine compounds such as ethylamine, propylamine, allylamine, butylamine, amylamine, octylamine, 3-methoxypropylamine and aniline; secondary amine compounds such as diethylamine, dipropylamine, diallylamine, dibutyl-amine and N-methylmethanolamine; tertiary amine compounds such as triethylamine, tripropylamine, triallylamine, tri-ethanolamine and N,N-dimethylethanolamine; and quaternary ammonium salt compounds such as tetramethyl ammonium hydroxide and trimethyl ammonium chloride. In view of solubility and reactivity, the primary, secondary and tertiary alkylamine compounds are most preferred among those amine compounds. The particularly preferred amine compound can be illustrated by, but not limited to, butylamine as the primary amine compound, dibutylamine as the secondary amine compound and tripropylamine as the tertiary amine compound.

As described above, the inclusion of the organic amine having a phenyl group improves dispersion of the metal oxide fine particles in the fluorene-based compound in which many phenyl groups exist, and accordingly reduces the occurrence of clouding even if the metal oxide fine particles are added. Examples of organic amines having a phenyl group include aniline, diphenylamine and the like.

The organic-inorganic composite forming material of this invention desirably contains the alkylamine in the amount of not exceeding 5% by weight. A molar ratio of the alkylamine to niobium oxide contained in the organic-inorganic forming material is desirably in the range of 0.2-2. If the amount of alkylamine is excessively small, dispersibility of the metal oxide fine particles in the organic solvent or resin may be lowered. On the other hand, if the amount of alkylamine exceeds 5% by weight, the strength of the resulting organic-inorganic composite may be lowered.

The organic amine having a phenyl group is preferably contained in the range of 2-5% by weight. If the amount of the organic amine having a phenyl group is excessively small, the metal oxide fine particles may become less dispersable in the fluorene-based compound. On the other hand, if it is excessively large, the resulting organic-inorganic composite is lowered in strength. This may increase the occurrence of cracks, for example, when it is subjected to a thermal shock.

The fluorene-based compound for use in the organic-inorganic composite forming material of this invention has an acryloyl or methacryloyl group and a basic skeleton consisting of bisarylfluorene whose structure is shown below.

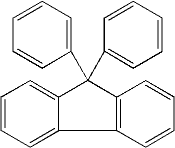

Specifically, a compound represented by the following general formula serves as an example, which has substituents having an acrylic or methacrylic group in the R₁ and R₂ positions.

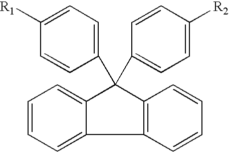

The fluorene-based compound having the structure shown below is generally commercially available. In the structure, n and m are generally in the range of 1-5.

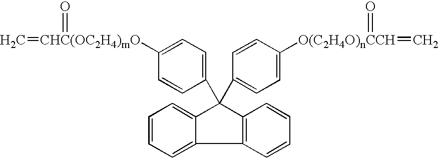

The fluorene-based compound used in Examples, a product name “OGSOL EA-0200” (manufactured by Osaka Gas Chemicals Co., Ltd.), has the following structure.

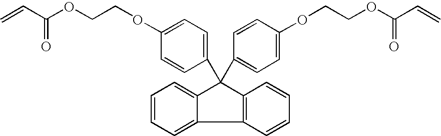

The fluorene-based compound having the above structure (9,9-bis[4-(2-acryloyloxyethoxy)phenyl]fluorene) is also sold in the market under the product designation “NK Ester A-BPEF” (manufactured by Shin-Nakamura Chemical Co., Ltd.)

The fluorene-based compound is preferably contained in the range of 30-85% by weight. Since the fluorene-based compound is a high-refractive index component, if its content is excessively small, a high-refractive organic-inorganic composite may not be obtained. On the other hand, if its content is excessively large, a relative content of the metal oxide fine particles is lowered, possibly leading to the failure to obtain a high-refractive organic-inorganic composite.

The acrylic monomer for use in this invention is an acrylic monomer other than the aforesaid fluorene-based compound, either polyfunctional or monofunctional. As the acrylic monomer, a polyfunctional acrylic monomer or oligomer and a monofunctional acrylic monomer or oligomer are preferably contained in combination. The acrylic monomer, as referred to in this specification, is a monomer having an acryloyl or methacryloyl group.

Inclusion of the polyfunctional acrylic monomer or oligomer increases a crosslinking density and accordingly increases the number of crosslinking groups per unit volume that is otherwise simply lowered by inclusion of the metal oxide fine particles.

Inclusion of the monofunctional acrylic monomer or oligomer increases flexibility of the resulting organic-inorganic composite and thus enhances its ability to absorb a physical shock.

A preferred example of the polyfunctional monomer is pentaerythritol triacrylate which is trifunctional. A preferred example of the monofunctional acrylic monomer is benzyl methacrylate. Preferably, pentaerythritol triacrylate and benzyl methacrylate are used in combination. Due to the inclusion of the OH group, pentaerythritol triacrylate can improve dispersibility of the metal oxide fine particles.

In the case where the polyfunctional acrylic monomer or oligomer and the monofunctional acrylic monomer or oligomer are used in combination, they are preferably mixed in the ratio (polyfunctional:monofunctional) by weight of 1:3-3:1. The resin flexibility can be controlled by varying the weight ratio within the above-specified range depending on the particular situation.

A bifunctional acrylate can also be used as the poly-functional acrylate. Further, this bifunctional acrylate can be used alone, instead of using the polyfunctional acrylate and monofunctional acrylate in combination. In such a case, the use of a bifunctional acrylate, such as dipropyl glycol diacrylate, 1,6-hexanediol diacrylate or tripropylene glycol diacrylate, is desirable. Besides such acrylates, methacrylates can also be used.

In this invention, any monomer which has an acryloyl or methacryloyl group can be used as the acrylic monomer However, the fluorene-based compound, because of its generally high viscosity, in some cases becomes difficult to handle in the molding process or the like. Accordingly, a low-viscosity monomer, rather than an oligomer, is preferably used to lower a total viscosity of the material. Such a low-viscosity monomer may be used as a diluent.

The organic-inorganic composite forming material of this invention preferably contains the acrylic monomer in the range of 10-35% by weight. The purpose of adding the acrylic monomer is to enhance strength of the organic-inorganic composite made via polymerization and thereby reduce the occurrence of cracks. Accordingly, if the acrylic monomer content is excessively small, the resin strength may be lowered to possibly increase the occurrence of cracks. On the other hand, if the acrylic monomer content is excessively large, it may become difficult to form a high-refractive organic-inorganic composite, because the acrylic monomer is generally low in refractive index.

The metal oxide fine particles in this invention can be illustrated by nanoparticles of a metal oxide such as of ZrO₂, Nb₂O₅ or Ti₂O₂. The use of Nb₂O₅ nanoparticles is particularly preferred. The nanoparticles of Nb₂O₅ (niobium oxide) are commercially available in the form of a liquid dispersion of niobium oxide nanoparticles in ethanol. For example, it is sold in the market under the product name “BYLAL” from Taki Chemical Co., Ltd., as described above. Some of such commercial products contain an alkylamine in advance as a dispersing agent.

The metal oxide fine particles are preferably contained in the range of 1-30% by weight. If the content of the metal oxide fine particles is excessively small, a high-refractive organic-inorganic composite may not be formed. On the other hand, if it is excessively large, the strength of the resulting organic-inorganic composite may be lowered to increase the occurrence of cracks.

The organic-inorganic composite forming material of this invention may further contain other component within the range that does not impair the effect of this invention.

Particularly, a hindered phenolic antioxidant if further contained retards the progress of yellowing of the organic-inorganic composite made via polymerization of the organic-inorganic composite forming material. The hindered phenolic antioxidant is preferably contained in the range of 0.1-0.3% by weight. The occurrence of yellowing of the organic-inorganic composite increases when fine particles of a metal oxide such as niobium oxide are contained.

The organic-inorganic composite of this invention is characterized in that it is obtained by polymerizing the aforementioned organic-inorganic composite forming material of this invention.

The organic-inorganic composite of this invention can be obtained, for example, by photopolymerizing the aforementioned organic-inorganic composite forming material of this invention. Generally, the forming material is polymerized by ultraviolet irradiation. Particularly, the forming material is preferably polymerized by exposure to an ultraviolet radiation having wavelengths of 365 nm and above, as will be described later.

The optical element of this invention is characterized in that it uses the aforementioned organic-inorganic composite of this invention. Examples of optical elements include an optical lens, diffraction grating, hologram element, prism element, antireflection multilayer film and waveguide element.

Also, a composite aspherical lens having a substrate and an overlying optical resin layer comprised of the organic-inorganic composite of this invention can be cited as the optical element.

The optical device of this invention is characterized in that it uses the optical element of this invention. Examples of optical devices include optical communication devices such as optical switches, optical transmitter and receiver modules and optical couplers; display devices such as liquid crystal displays, plasma displays, organic EL displays and projectors; optical parts such as microlens arrays, integrators and light guides; cameras such as digital cameras; image pickup devices such as video cameras; image pickup modules such as CCD camera modules and CMOS camera modules; and optical apparatuses such as telescopes, microscopes and magnifying glasses.

The method of this invention for production of the organic-inorganic composite is a method which produces the organic-inorganic composite using the organic-inorganic composite forming material of this invention and characterized in that it includes the steps of preparing a liquid dispersion of the aforementioned metal oxide fine particles, the liquid dispersion containing the aforementioned alkylamine and organic amine; adding the aforementioned acrylic monomer, photoinitiator and fluorene-based compound to the liquid dispersion to prepare an organic-inorganic composite forming material; and polymerizing the organic-inorganic forming material to form an organic-inorganic composite.

In accordance with the production method of this invention, the metal oxide fine particles can be dispersed in the fluorene-based resin without causing clouding, leading to production of the organic-inorganic composite having a high refractive index.

In the preparation of the organic-inorganic composite forming material, a solvent can be used. The solvent is not particularly specified, as long as it can dissolve each organic component. Examples of solvents include acetone, methyl ethyl ketone and methyl isobutyl ketone.

In the production method of this invention, the organic-inorganic composite forming material is preferably polymerized by exposure to an ultraviolet radiation to form the organic-inorganic composite. In this case, more preferably, polymerization is carried out by exposure to an ultraviolet radiation having wavelengths of 365 nm and above. Exposure to an ultraviolet radiation having wavelengths of 365 nm and above can be achieved, for example, by using a filter that only transmits an ultraviolet radiation in the wavelength range of 365 nm and above. Examples of filters include an absorption type filter which only transmits an ultraviolet radiation in the range of not below a particular wavelength, and a line interference filter which only transmits a particular wavelength.

### EFFECT OF THE INVENTION

In accordance with this invention, metal oxide fine particles are dispersed in the fluorene-based resin without the occurrence of clouding so that the organic-inorganic composite having a high refractive index can be formed.

### BRIEF DESCRIPTION OF THE DRAWINGS

FIG. 1 is a schematic sectional view which shows an optical element embodiment according to this invention;

FIG. 2 is a schematic sectional view which shows a camera module as an optical device embodiment according to this invention;

FIG. 3 is a sectional view which shows a folding mobile telephone incorporating the conventional camera module;

FIG. 4 is sectional view which shows a mobile telephone embodiment according to this invention; and

FIG. 5 is a schematic sectional view which shows a diffraction grating as an optical element embodiment of this invention.

### DESCRIPTION OF THE PREFERRED EXAMPLES

The following specific examples illustrate the present invention but are not intended to be limiting thereof.

The respective liquid dispersions of Nb₂O₅ nanoparticles and TiO₂ nanoparticles for use in the following Examples and Comparative Examples were prepared according to the following procedures.

(Preparation of Liquid Dispersion of Nb₂O₅ Nanoparticles)

A citric acid monohydrate was added to a commercially available, oxalic acid stabilized niobium oxide sol (product of Taki Chemical Co., Ltd., Nb₂O₅=10.2 wt. %, oxalic acid/Nb₂O₅ (molar ratio) =0.62) such that citric acid/Nb₂O₅ (molar ratio) was brought to 0.20. Thereafter, an aqueous ammonia solution (15 wt. %) was used to adjust the sol to a pH of 8.5. This sol was subjected to ultrafiltration using an ultrafiltration system (MICROZA UF, Model No. SLP-1053, product of Asahi Kasei Corp.) so that the Nb₂O₅ concentration was adjusted to 20% by weight. Then, a citric acid monohydrate was added to provide citric acid/Nb₂O₅ (molar ratio) =0.15. The resulting oxalic acid-citric acid stabilized niobium oxide sol exhibited pH3.8, citric acid/oxalic acid (molar ratio) =1.94 and oxalic acid/Nb₂O₅ (molar ratio) =0.18. The resulting sol showed a niobium oxide concentration of 10% by weight.

An n-butylamine was added to the thus-obtained oxalic acid-citric acid stabilized niobium oxide sol while stirred such that n-butylamine/Nb₂O₅ (molar ratio) was brought to 0.6. 600 g of ethanol was added to the sol which was subsequently concentrated by a rotary evaporator to a total amount of 200 g. The concentrating operation was repeated four times to sequentially improve a percentage of substitution of organic solvent. The sol was subsequently concentrated to a total amount of 130 g to obtain an ethanol dispersion of niobium oxide nanoparticles, which exhibited an Nb₂O₅ concentration of 30.5% by weight, a water content of 1.9% by weight, a mean particle diameter of 10.2 nm, a haze percentage of 6.7% and a viscosity of 13.5 up. This dispersion was adjusted using ethanol to an Nb₂O₅ concentration of 20% by weight to provide a liquid dispersion of Nb₂O₅ nanoparticles.

(Preparation of Liquid Dispersion of TiO₂ Nanoparticles)

2,212 g (NH₃/Cl equivalent ratio=1.3) of ammonia water (NH₃=2 wt. %) was gradually added under agitation at room temperature to 2,000 g of an aqueous titanium oxychloride (TiO₂=2 wt. %) to produce a titanium hydroxide gel. This was filtered and washed with water until a chlorine ion in the filtrate falls to 100 ppm or below with respect to the titanium gel (TiO₂), thereby obtaining a gel with TiO₂=10% by weight and NH₃=0.3% by weight.

To 400 g of this titanium oxide gel, 3.66 g of n-butylamine (at n-butylamine/TiO₂ molar ratio=0.1) and 27.2 g of a 70 wt. % glycolic acid (product of Wako Pure Chemical Co., Ltd.) at glycolic acid/TiO₂ (molar ratio) =0.5 were added. This was introduced in an autoclave where it was hydrothermally treated at 120° C. for 6 hours to obtain a crystalline titanium oxide sol (TiO₂=9.3 weight %). Then, 100 g of this sol was repeatedly azeotropically distilled with the addition of ethanol to obtain an ethanol dispersion of TiO₂ nanoparticles. Analysis of this liquid dispersion revealed TiO₂=20% by weight, n-butylamine=1.5% by weight, glycolic acid=5.7% by weight, n-butylamine/TiO₂ (molar ratio) =0.08, glycolic acid/TiO₂ (molar ratio) =0.3 and a water content in a dispersing medium of 4% by weight.

### Example 1

(1) 0.028 ml of aniline, 0.049 ml of pentaerythritol triacrylate, 0.096 ml of benzyl methacrylate and 0.016 g of a photoinitiator (product name: IRGACURE 184) were sequentially added with stirring to 0.5 ml of the above-prepared liquid dispersion of Nb₂O₅ nanoparticles which was subsequently heated at 90° C. to evaporate ethanol. 1 ml of acetone was added and dissolved in the liquid rendered viscous after removal of ethanol to obtain a liquid (A).

(2) 0.582 g of a bifunctional fluorene-based acrylate (product of Osaka Gas Chemical Co., Ltd., product name “OGSOL EA-0200”) was dissolved in 1 ml acetone to obtain a liquid (B).

(3) The liquid (B) was added to the liquid (A). The mixture was heated at 90° C. to evaporate acetone and then allowed to stand at 110° C. for 30 minutes to thereby fully remove the remaining acetone, so that an organic-inorganic composite forming material was obtained.

The content of each component in the organic-inorganic composite forming material is shown in Table 1.

TABLE 1

| Component | Amount (wt. %) |
|---|---|
| Nb₂O₅ | 11.2 |
| Aniline | 3.0 |
| Pentaerythritol Triacrylate | 5.5 |
| Benzyl Methacrylate | 10.5 |
| IRGACURE 184 | 1.8 |
| EAO200 | 63.1 |
| n-butylamine Contained | 2.1 |
| Other Dispersants Contained in Liquid Dispersion | 2.7 |

The organic-inorganic forming material was polymerized and cured by ultraviolet irradiation to obtain an organic-inorganic composite. Measurement of this organic-inorganic composite revealed a refractive index of 1.63 and an Abbe number of 26.

Although the aniline content of the above-described organic-inorganic composite forming material was 3% by weight, the amount of aniline added was varied to prepare organic-inorganic composite forming materials having aniline contents of 2% by weight, 5% by weight and 10% by weight in accordance with the above-outlined procedure.

The organic-inorganic composite forming materials having aniline contents of 2% by weight, 3% by weight, 5% by weight and 10% by weight were each applied onto a BK-7 glass coated with a silane coupling agent and then cured by exposure to an ultraviolet radiation to provide a 120 μm thick plate-like organic-inorganic composite.

The obtained organic-inorganic composites were measured for transmittance at a wavelength of 430 nm. The measurement results revealed a transmittance of 74% for the composite derived from the forming material having an aniline content of 2% by weight, a transmittance of 82% for the composite derived from the forming material having an aniline content of 3% by weight, a transmittance of 80% for the composite derived from the forming material having an aniline content of 5% by weight, and a transmittance of 79% for the composite derived from the forming material having an aniline content of 10% by weight. The forming material having an aniline content of 2% by weight has been confirmed to form a resin which is somewhat lower in transmittance but transparent as a whole.

Further, each plate-like organic-inorganic composite was subjected to an abrupt temperature change to examine the occurrence of cracks. The abrupt temperature change was imposed by transferring each sample quickly between a high-temperature tank at 120° C. and a freezing tank at −50° C. Each sample was maintained at 120° C. for 20 minutes, then at −50° C. for 20 minutes, further at 120° C. for 20 minutes and finally returned to a room temperature to observe a surface of the organic-inorganic composite. As a result, no appreciable surface change was observed for the composites derived from the forming materials having aniline contents of 2% by weight, 3% by weight and 5% by weight. In contrast, cracks were observed on a surface of the organic-inorganic composite derived from the forming material having an aniline content of 10% by weight.

### Comparative Example 1

The procedure of Example 1 was followed, except that aniline was excluded, to prepare an organic-inorganic composite material.

Due to agglomeration of niobium oxide nanoparticles, the obtained organic-inorganic composite forming material was in a cloudy condition. This prevented measurement of both a refractive index and an Abbe number of the material.

### Example 2

An organic-inorganic composite forming material was prepared in accordance with the procedure of Example 1 with the following modifications: 0.5 ml of the liquid dispersion of Nb₂O₅ nanoparticles, 0.028 ml of aniline, 0.01 ml of pentaerythritol triacrylate, 0.148 g of hydroxyethyltribromo phenol acrylate (manufactured by Dai-ichi Kogyo Seiyaku Co., Ltd., product name: “New Frontier BR-31”) and 0.015 g of the photoinitiator were used.

The organic-inorganic composite forming material was then cured by ultraviolet irradiation into an organic-inorganic composite. Measurement thereof revealed a refractive index of 1.63 and an Abbe number of 26.

Also following the procedure of Example 1, a 120 μm thick plate-like organic-inorganic composite was prepared and then subjected to an abrupt temperature change to examine the occurrence of cracks. No appreciable cracks were observed.

### Example 3

In this Example, a bifunctional acrylate is used for the acrylic monomer, instead of using a polyfunctional acrylate and a monofunctional acrylate in combination.

An organic-inorganic composite forming material was prepared in accordance with the procedure of Example 1 with the following modifications: 0.5 ml of the liquid dispersion of Nb₂O₅ nanoparticles, 0.028 ml of aniline, 0.12 ml of dipropylene glycol diacrylate and 0.015 g of the photoinitiator were used.

An organic-inorganic composite was prepared in the same manner as above and then measured. The measurement results revealed a refractive index of 1.62 and an Abbe number of 26.

Also in the same manner as above, it was subjected to an abrupt temperature change to examine the occurrence of cracks. No appreciable cracks were observed.

### Example 4

(1) 0.1 ml of benzyl methacrylate and 0.016 g of a photoinitiator (product name “IRGACURE 184”) were sequentially added with stirring to 0.6 ml of the above-prepared liquid dispersion of TiO₂ nanoparticles which was subsequently heated at 90° C. to evaporate ethanol. 1 ml of acetone was added and dissolved in the liquid rendered viscous after removal of ethanol to obtain a liquid (A).

(2) 0.582 g of a bifunctional fluorene-based acrylate similar to the above was dissolved in 1 ml acetone to obtain a liquid (B).

(3) The liquid (B) and 0.045 ml of aniline were added to the liquid (A). The mixture was heated at 90° C. to evaporate acetone and then kept at 110° C., for 30 minutes to fully remove any remaining acetone, so that an organic-inorganic composite forming material was obtained.

This organic-inorganic forming material was cured by exposure to an ultraviolet radiation to obtain an organic-inorganic composite. Measurement of the organic-inorganic composite revealed a refractive index of 1.65 and an Abbe number of 25.

### Example 5

(1) 0.028 ml of aniline, 0.049 ml of pentaerythritol triacrylate, 0.096 ml of benzyl methacrylate, 0.014 g of a photoinitiator (product name “IRGACURE 184”) and 0.003 g of a hindered phenolic antioxidant (product name “Sumilizer”, product of Sumitomo Chemical Co., Ltd.) were sequentially added with stirring to 0.5 ml of the above-prepared liquid dispersion of Nb₂O₅ nanoparticles which was subsequently heated to 90° C. to evaporate ethanol. 1 ml of acetone was added and dissolved in the liquid rendered viscous after removal of ethanol to obtain a liquid (A).

(2) 0.582 g of a bifunctional fluorene-based acrylate (product of Osaka Gas Chemical Co., Ltd., product name “OGSOL EA-0200”) previously containing 0.003 g of a sulfur secondary antioxidant (product of Osaka Gas Chemical Co., Ltd., product name “OGSOL EA-0200”) was dissolved in 1 ml acetone to obtain a liquid (B).

(3) The liquid (B) was added to the liquid (A). The mixture was heated at 90° C. to evaporate acetone and then allowed to stand at 110° C. for 30 minutes to thereby fully remove any remaining acetone, so that an organic-inorganic composite forming material was obtained.

The content of each component in the organic-inorganic composite forming material is shown in Table 2.

TABLE 2

| Component | Amount (wt. %) |
|---|---|
| Nb₂O₅ | 11.2 |
| Aniline | 3.1 |
| Pentaerythritol Triacrylate | 10.8 |
| Benzyl Methacrylate | 5.4 |
| IRGACURE 184 | 1.5 |
| EA0200 | 62.8 |
| n-butylamine Contained in Liquid Dispersion | 2.1 |
| Other DispersantsContained in Liquid Dispersion | 2.7 |
| Sumilizer GA-80 | 0.3 |
| Sumilizer TP-D | 0.3 |

The organic-inorganic forming material was polymerized and cured by ultraviolet irradiation to obtain an organic-inorganic composite. Measurement of this organic-inorganic composite revealed a refractive index of 1.63 and an Abbe number of 26.

(Evaluation of Yellowing Tendency of Organic-Inorganic Composite)

The organic-inorganic forming material was applied onto a borosilicate glass substrate and then cured by ultraviolet irradiation to form a 140 μm thick film of an organic-inorganic composite. The SP-7 system, manufactured by Ushio Inc., was used as a source of ultraviolet radiation. An absorption type filter was used to exclude wavelengths of shorter than 365 nm, such as 254 nm and 313 nm, from the ultraviolet radiation emitted from an ultra-high-pressure mercury lamp incorporated in the Ushio SP-7. Accordingly, the organic-inorganic forming material was cured by exposure to an ultraviolet radiation having wavelengths of 365 nm (i-line) and above. After cured, it was baked at 120° C. for 6 hours to remove remaining volatiles such as acetone.

A transmittance at 430 nm of the obtained sample of organic-inorganic composite was measured and found to be 80.2%. This sample was subjected to a high-temperature high-humidity test (85° C.-85%) as a 500-hour accelerated test and then its transmittance at 430 nm was again measured and determined to be 79.1%. Hence, a difference between transmittance before and after the high-temperature high-humidity test was −1.1%. Since the transmittance of the organic-inorganic composite remained almost unchanged, its yellowing tendency was confirmed to be extremely low.

### Example 6-17

Instead of using Sumilizer GA-80 and Sumilizer TP-D, the additives specified in Table 3 were used in the respective amounts also specified therein Otherwise, the procedure of Example 5 was followed to prepare organic-inorganic composite forming materials.

Using each organic-inorganic composite forming material prepared, a sample of organic-inorganic composite was prepared in accordance with the procedure of Example 5. However, in Examples 7-16, ultraviolet irradiation was carried out without using the filter. Accordingly, the samples were exposed to the ultraviolet radiation even including wavelengths of below 365 nm.

The transmittance at 430 nm of each organic-inorganic composite sample, both before and after the high-temperature high-humidity test, was measured in the same manner as in Example 5. The measurement results are shown in Table 3.

The additives specified in Table 3 are as follows.

IRGANOX 1076: a hindered phenolic antioxidant, manufactured by Ciba Specialty Chemicals Corporation

Sumilizer DS: a stabilizer, for butadiene-based polymers, containing a phenolic compound as an active component and having an intramolecular double bond capable of trapping a polyalkyl radical under the absence of oxygen during processing, manufactured by Sumitomo Chemical Co., Ltd.

IRGANOX 1010: a hindered phenolic antioxidant, manufactured by Ciba Specialty Chemicals Corporation

Such additives were not used in Examples 16 and 17 in the preparation of organic-inorganic composites.

When in use, Sumilizer GA-80 was added to the liquid (A), while Sumilizer TP-D, Sumilizer GS, IRGANOX 1076 and IRGANOX 1010 were each mixed in a bifunctional fluorene-based acrylate (EA-0200), as shown in the above Example 5.

### Comparative Example 2

An organic-inorganic composite forming material was prepared to which niobium oxide particles as the metal oxide fine particles were not added. Specifically, 70% by weight of a bifunctional fluorene-based acrylate (EA-0202), 28.5% by weight of phenoxyethyl acrylate (product of Shin-Nakamura Chemical Co., Ltd., product name “NK Ester AMP-10G”), 1.5% by weight of IRGACURE 184 (1-hydroxy-cyclohexyl-phenyl-ketone) and acetone as a solvent were used to prepare a solution of an organic-inorganic composite forming material.

Using this organic-inorganic composite forming material, the procedure of Example 5 was followed, except that ultraviolet irradiation was performed without using the filter, to form a film of an organic-inorganic composite.

The transmittance at 430 nm of this comparative film, both before and after the high-temperature high-humidity test, was measured in the same manner as in Example 5. The measurement results are shown in Table 3.

TABLE 3

| | | | | Filter During | | | |
|---|---|---|---|---|---|---|---|
| | Additive | | Niobium | Ultraviolet | Transmittance at 430 nm | | |
| | Type | Amount (wt. %) | Oxide | Irradiation | Before Test | After Test | Difference |
| Ex. 5 | Sumilizer GA-80/Sumilizer TP-D | 0.3/0.3 | Present | Present | 80.2 | 79.1 | −1.1 |
| Ex. 6 | IRGANOX 1076 | 0.3 | Present | Present | 75.6 | 74.7 | −0.9 |
| Ex. 7 | Sumilizer GS | 0.1 | Present | Absent | 72.7 | 50.2 | −22.5 |
| Ex. 8 | Sumilizer GA-80 | 0.1 | Present | Absent | 73.1 | 71.8 | −1.3 |
| Ex. 9 | Sumilizer GA-80 | 0.3 | Present | Absent | 72.2 | 63.6 | −8.6 |
| Ex. 10 | Sumilizer GA-80/Sumilizer TP-D | 0.1/0.1 | Present | Absent | 74.4 | 67.4 | −7.0 |
| Ex. 11 | Sumilizer GA-80/Sumilizer TP-D | 0.3/0.3 | Present | Absent | 76.3 | 66.2 | −10.1 |
| Ex. 12 | IRGANOX 1010 | 0.1 | Present | Absent | 73.4 | 69.6 | −3.8 |
| Ex. 13 | IRGANOX 1010 | 0.3 | Present | Absent | 73.5 | 66.1 | −7.4 |
| Ex. 14 | IRGANOX 1076 | 0.1 | Present | Absent | 70.0 | 60.1 | −9.9 |
| Ex. 15 | IRGANOX 1076 | 0.3 | Present | Absent | 77.4 | 73.8 | −3.6 |
| Ex. 16 | None | — | Present | Absent | 70.0 | 53.0 | −17.0 |
| Ex. 17 | None | — | Present | Present | 79.1 | 59.3 | −19.8 |
| Comp. Ex. 2 | None | — | Absent | Absent | 85.8 | 84.4 | −1.4 |

As can be clearly seen from Table 3, the composites made in Examples 6 and 8-15 using the hindered phenolic antioxidant as an additive showed smaller differences between transmittance before and after the high-temperature high-humidity test, compared to those made in Examples 7 and 16-17 excluding the hindered phenolic antioxidant, demonstrating the reduced yellowing tendency. In particular, an extremely low yellowing tendency is shown for the composites made in Examples 5 and 6 where ultraviolet irradiation was performed using the filter so that the forming material was exposed to an ultraviolet radiation having wavelength of 365 nm and above.

As can be appreciated from comparison between Example 17 where the additive was excluded and ultraviolet irradiation was performed using the filter and Example 16 where the additive was excluded and ultraviolet irradiation was performed without using the filter, if ultraviolet irradiation was performed through the filter so that the forming material was exposed to an ultraviolet radiation having wavelengths of 365 nm and above, a high transmittance is attained for the composite both before and after the high-temperature high-humidity test. It is accordingly understood that a high-transmittance organic-inorganic composite is obtained by performing ultraviolet irradiation through the filter so that the forming material was exposed to an ultraviolet radiation having wavelengths of 365 nm and above.

In Comparative Example 2 in which niobium oxide was excluded, a difference between transmittance before and after the high-temperature high-humidity test is small. It is thus understood that the yellowing tendency of the organic-inorganic composite increases when it contains the metal oxide fine particles or amine compound. In this invention, the metal oxide fine particles are incorporated for the purpose of increasing a refractive index of the organic-inorganic composite. On the other hand, inclusion of the metal oxide fine particles presents a problem of increasing a yellowing tendency of the composite. This yellowing tendency can be reduced by inclusion of the hindered phenolic antioxidant, as described above. Also, in the case where polymerization is effected by ultraviolet irradiation, the use of the filter that excludes wavelengths of shorter than 365 nm but transmits wavelengths of 365 nm and above further reduces the yellowing tendency.

### Example 18

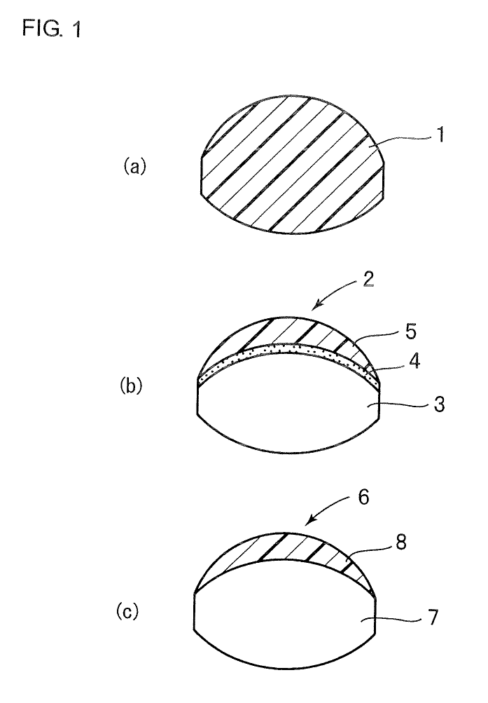

FIG. 1 is a sectional view which shows an embodiment of an optical element in accordance with this invention. FIG. 1(a) shows an aspherical lens 1 made of the organic-inorganic composite of this invention. Such an aspherical lens 1 can be fabricated as by processing the organic-inorganic composite forming material of this invention in a mold.

FIG. 1(b) shows a composite aspherical lens 2 using the organic-inorganic composite of this invention. An optical resin layer 5 comprised of the organic-inorganic composite of this invention is formed on an optical substrate 3 through a silane coupling agent layer 4 such as by molding.

Although the optical substrate 3 may comprise a glass, plastic or ceramic, a high-refractive index glass (product of Ohara Inc., product name “S-LAH79”, refractive index of about 2.0) is used in this Example.

FIG. 1(c) shows an aspherical lens 6 which has an optical resin layer comprising the organic-inorganic composite of this invention. The optical resin layer 8 comprising the organic-inorganic composite is formed on an optical substrate 7 such as by molding. In this Example, a plastic (cycloolefin polymer manufactured by Nippon Zeon Co., Ltd., product name “ZEONEX”) is used for the optical substrate 7. The use of a plastic improves adhesion between the optical substrate and the organic-inorganic composite, which allows direct formation of the optical resin layer 8 on the optical substrate 7.

The aspherical lenses shown in FIGS. 1(a) and 1(b) are fabricated by depositing an aspherically-shaped optical resin layer on an optical substrate comprised of a spherical lens.

### Example 19

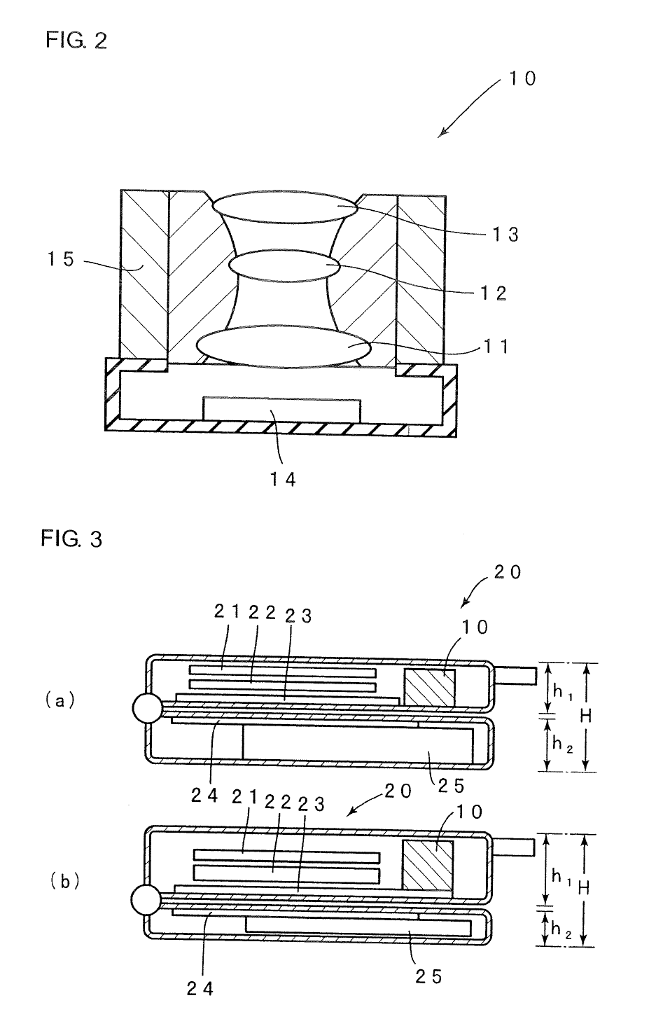

FIG. 2 is a schematic sectional view which shows a camera module 10 using a composite aspherical lens as shown in FIG. 1. As shown in FIG. 2, three aspherical lenses 11, 12 and 13 are located above an image pickup element 14 and held in positions by an auto-focus mechanism 15. The camera module 10 having these three aspherical lenses 11-13 can be used as a 2-5 megapixel camera module for mobile telephones.

In this Example, the composite aspherical lens of FIG. 1(c) is used for the aspherical lenses 11-13. Since the composite aspherical lens shown in FIG. 1(c) uses the high-refractive organic-inorganic composite of this invention for the optical resin layer 8, the number of lenses, generally four, can be reduced to 3. Accordingly, the camera module of this Example can be reduced in height to about 7.5 mm.

Although the lenses 11-13 are all specified as being aspherical in this Example, not all of them need to be aspherical if the camera module design permits. At least one of them needs to be an aspherical lens. The camera module shown in FIG. 2 has a lens system comprising a combination of plural lenses, an image pickup element and a holder for retaining them. Characteristically, at least one of those plural lenses comprises the optical element of this invention as it is used as the aspherical lens.

Conventional camera modules for mobile telephones need four lenses, since an optical resin layer of each lens installed therein is limited in refractive index to 1.61 or below. This forces the conventional camera modules to have a height of about 10 mm.

FIG. 3 is a sectional view which shows a folding mobile telephone incorporating a 10 mm high, conventional camera module.

The mobile telephone in a folded position, as shown in FIGS. 3(a) and 3(b), has a height H of 25 mm. In the mobile telephone shown in FIG. 3(a), a height h₁ of its upper section is 12.5 mm and equal to a height h₂ of its lower section. The upper section has a camera module 10 and accommodates a TV tuner 21, a hard disk drive 22 and a display 23. Since the upper section in FIG. 3(a) has a relatively small height h₁ of 12.5 mm, the camera module 10 limits an available space for the display 23 which is thus forced to reduce in size. A keyboard 24 and a battery 25 are located inside the lower section.

In the mobile telephone shown in FIG. 3(b), the upper section has a height h₁ of 14.5 mm and the lower section has a height h₂ of 10.5 mm. This design contemplates to increase the height h₁ of the upper section for accommodation of the display 23 of a larger size. On the other hand, the height h₂ of the lower section is reduced to 10.5 mm. This forces a reduction in volume of the battery 25 and accordingly lowers a battery capacity, which has been a problem.

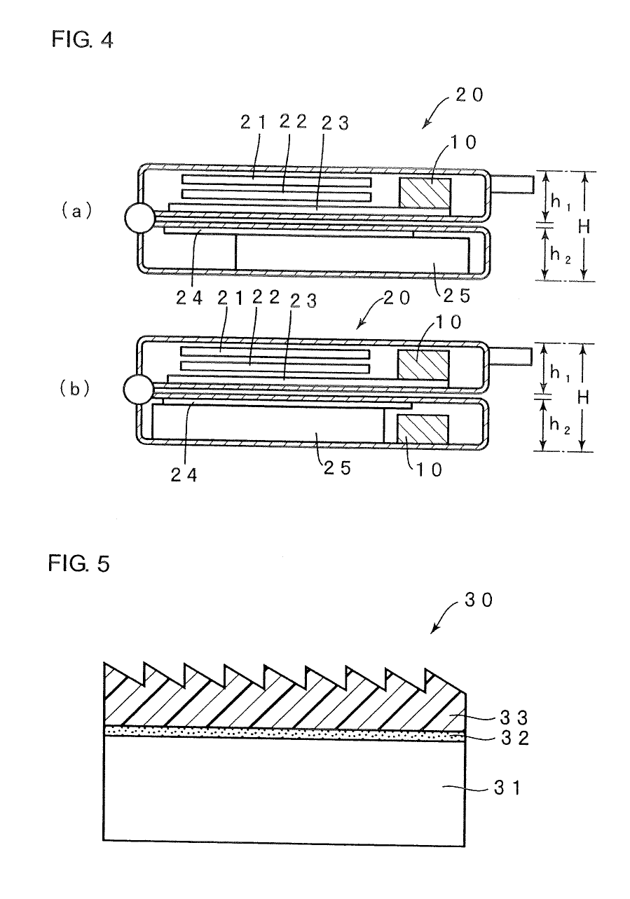

FIG. 4 is a sectional view which shows an embodiment of a mobile telephone in accordance with the present invention.

In the mobile telephones shown in FIG. 4(a) and 4(b), a camera module 10 is incorporated which is the optical device of the present invention. Since the camera module 10 of this invention can be reduced in height, for example, to about 8 mm, a large-size display 23 can be incorporated in the upper section, as shown in FIG. 4(a), without the need to increase its height h₁. This allows the lower section and the upper section to have the same height h₂ and h₁ of 12.5 mm, which permits accommodation of the battery 25 of a larger capacity in the lower section.

Also, the camera module 10 can be incorporated in each of the upper and lower sections, as shown in FIG. 4(b) This enables one to photograph a stereoscopic visual image or its own face with a high image quality. Other applications become possible. For example, panoramic shooting can be achieved by using plural cameras. The sensitivity can be substantially improved by electrically composing output signals from plural cameras.

### Example 20

The camera module shown in FIG. 2 is also useful as a camera module of a back monitor for use in cars. The back monitor for use in cars requires durability against temperature change and can employ the aspherical lens of FIG. 1(c), for example. In addition, the aspherical lens of FIG. 1(c) widens an angle of visual field because of its high refractive index.

### Example 21

FIG. 5 is a schematic sectional view which shows a diffraction grating as another embodiment of the optical element of the present invention. A layer 32 of a silane coupling agent is deposited on a glass substrate 31, and a diffraction grating layer 33 comprising the organic-inorganic composite of this invention is deposited on the silane coupling agent layer 32. The silane coupling agent layer 32 can be deposited by applying the silane coupling agent onto the substrate 31. The diffraction grating layer 33 can be formed by processing the organic-inorganic composite forming material of this invention by a stamping process. The organic-inorganic composite of this invention has a high refractive index, as described above, and thus can size up the diffraction grating. Therefore, it is suitable as a material for formation of a diffraction grating.

The diffraction grating 30 can be used in a wide variety of fields, e.g., in optical parts such as a light pickup, spectroscope, optical communication device and fresnel lens.

What is claimed is:

1. An organic-inorganic composite forming material characterized in that it contains a fluorene-based compound having an acryloyl or methacryloyl group, an acrylic monomer other than said fluorene-based compound, metal oxide fine particles, an alkylamine, an organic amine having a phenyl group, and a photoinitiator.

2. The organic-inorganic composite forming material as recited in claim 1, characterized in that said organic amine is aniline or diphenylamine.

3. The organic-inorganic composite forming material as recited in claim 1, characterized in that said organic amine is contained in the amount of 2-5% by weight.

4. The organic-inorganic composite forming material as recited in claim 1, characterized in that said metal oxide fine particles are niobium oxide fine particles.

5. The organic-inorganic composite forming material as recited in claim 1, characterized in that a polyfunctional acrylic monomer or oligomer and a monofunctional acrylic monomer or oligomer are contained as said acrylic monomer.

6. The organic-inorganic composite forming material as recited in claim 1, characterized in that it further contains a hindered phenolic antioxidant.

7. An organic-inorganic composite characterized in that it is obtained by polymerizing the organic-inorganic composite forming material as recited in claim 1.

8. An organic-inorganic composite characterized in that it is obtained by polymerizing the organic-inorganic composite forming material as recited in claim 2.

9. An organic-inorganic composite characterized in that it is obtained by polymerizing the organic-inorganic composite forming material as recited in claim 3.

10. An organic-inorganic composite characterized in that it is obtained by polymerizing the organic-inorganic composite forming material as recited in claim 4.

11. An organic-inorganic composite characterized in that it is obtained by polymerizing the organic-inorganic composite forming material as recited in claim 5.

12. An organic-inorganic composite characterized in that it is obtained by polymerizing the organic-inorganic composite forming material as recited in claim 6.

13. An optical element characterized in that it uses the organic-inorganic composite as recited in claim 7.

14. The optical element as recited in claim 13, characterized in that it is a composite aspherical lens having an optical resin layer provided on a substrate and comprising the organic-inorganic composite as recited in claim 7.

15. An optical device characterized in that it uses the optical element as recited in claim 13.

16. An optical device characterized in that it uses the optical element as recited in claim 14.

17. A method for production of an organic-inorganic composite using the organic-inorganic composite forming material as recited in claim 1, characterized in that it comprises the steps of:
preparing a liquid dispersion of said metal oxide fine particles, the liquid dispersion containing said alkylamine and said organic amine;
adding said acrylic monomer, said photoinitiator and said fluorene-based compound to the liquid dispersion to prepare an organic-inorganic composite forming material; and
polymerizing said organic-inorganic composite forming material to produce an organic-inorganic composite.

18. The method for production of an organic-inorganic composite as recited in claim 17, characterized in that said organic-inorganic composite forming material is polymerized by exposure to an ultraviolet radiation.

19. The method for production of an organic-inorganic composite as recited in claim 18, characterized in that said ultraviolet radiation has wavelengths of 365 nm and above.
